(19) United States
(12) Patent Application Publication
(10) Pub. No.: US 2025/0039165 A1
(43) Pub. Date: Jan. 30, 2025

(54) METHOD AND MOBILE APPARATUS FOR RENDERING CODE, METHOD AND SYSTEM FOR AUTHENTICATING DIGITAL CERTIFICATE

(71) Applicant: IDEMIA IDENTITY & SECURITY FRANCE, Courbevoie (FR)

(72) Inventors: Brian Keith MARTIN, Courbevoie (FR); Matthew WISE, Courbevoie (FR); Harold WIEDIGER, Courbevoie (FR)

(73) Assignee: IDEMIA IDENTITY & SECURITY FRANCE, Courbevoie (FR)

(21) Appl. No.: 18/786,105

(22) Filed: Jul. 26, 2024

(30) Foreign Application Priority Data
Jul. 28, 2023 (FR) 2308229

(51) Int. Cl. H04L 9/40; H04L 9/08

(52) U.S. Cl. CPC H04L 63/0823; H04L 9/0872

(57) ABSTRACT

A method for rendering a code is provided. The method is implemented by a first mobile apparatus and includes: obtaining (S201) a digital certificate; obtaining (S202) information representing a time and/or a location; obtaining (S203) a code generated using a code generating model based on the information representing the time and/or the location; and displaying (S204) the code along with at least one element that is comprised in the digital certificate on a display of the first mobile apparatus.

### TECHNICAL FIELD

The present disclosure relates generally to the field of authentication, and, in particular, to a method and a mobile apparatus for rendering a code used for authenticating a person, and a method and a system for authenticating a digital certificate.

### BACKGROUND

There are scenarios in everyday life that require certificate verification. For example, alcohol vendors check the identification (hereinafter “ID”) documents of some customers buying alcoholic beverages to ensure the customers are of legal drinking age; pharmacies require a doctor's prescription to be produced before selling prescription drugs, etc. Besides, digital certificates are widely accepted nowadays (e.g., a digital driver's license). However, digital certificates which are only visually verified may be easily forged or doctored, making it difficult for the verifier to discern between genuine and fraudulent certificates.

U.S. Pat. No. 10,331,291B1 proposes a simple and efficient solution to the above problem, where a subset of predetermined visual indicators are selected and displayed on a digital identification according to a pre-defined pattern to enable verification of the digital identification without any additional detector devices.

Yet more secure solutions are still required.

### SUMMARY

In a first aspect, the present disclosure provides a method for rendering a code. The method is implemented by a first mobile apparatus. The method includes:
obtaining a digital certificate comprising at least one element;
obtaining information representing a time and/or a location;
obtaining a code generated using a code generating model based on the information representing the time and/or the location; and
displaying the code along with the at least one element that is included in the digital certificate on a display of the first mobile apparatus,
the code generating model being a deep generative model and the entropy of the code is lower than a given threshold, the code being a graphical code displayed as a background of the digital certificate.

In particular, the digital certificate may be a digital identification document.

The code is a graphical code, which is a visual representation that presents graphical or pictorial information. Examples of the graphical code include a three-dimensional (“3D”) model or point cloud, a synthetic image, etc. Alternatively, the code may be text or numerical data.

The “at least one element” may be information/data required for authenticating the digital certificate. The at least one element may include a part of the digital certificate containing the required data or may include the required data only. For example, the at least one element may be selected from a group including a facial photograph, the full name, driver's license number, and date of birth of the digital certificate owner, the digital certificate issue date, the digital certificate expiration date, etc.

Furthermore, as used herein, the term “code generating model” refers to a generative model that is an algorithm, a function or a neural network which is adapted to generate a code based on information representing a time and/or a location.

In contrast with the solutions of the prior art, the above method proposes to generate a code using a code generating model based on information representing a specific time and/or a specific location and to display the code together with at least one element contained in a digital certificate. As such, the appearance/content of the code could be unpredictable because there is no list of patterns that can be learned or observed for future use, and changes in the information representing time and/or the location will be reflected in the code. Accordingly, using the code to verify the digital certificate could be simple, efficient and more secure than the prior art.

In particular, the code generating model may be configured to generate the same code based on given information representing a time and/or a location. That is, the model will output the same code when provided with the same information.

For instance, the model is configured to always generate the same code based on information representing the same time or representing the same time and the same location, independently of the user's identity, and in particular independently of the user's personal identification data present in the user's digital certificate, enabling the code to be easily verified by the verifier by comparing the code with the one generated on his or her own mobile device.

Further, the code generating model may be configured to generate different codes based on different information each representing a different time or a different location.

In particular, if a deep generative model is used and the information representing the time and/or the location is input into the model to generate the code, various methods can be used to increase the model's sensitivity to input changes.

Example methods include selecting a deep generative model which can be made highly sensitive to changes in input, such as a generative adversarial network (hereinafter “GAN”) or a variational autoencoder (hereinafter “VAE”). And/or, a loss function that encourages diversity in the generated codes can be used to train the deep generative model. And/or, unencrypted information that represents a time and/or a location may be transformed using a cryptographic technique such as a hash algorithm, where the transformed information (also referred to as “encrypted information” herein), or, both the unencrypted and transformed information, may be used as the input to the model. For instance, the hash value will change dramatically with even small changes in the unencrypted information.

In a particular example, the first mobile apparatus obtains information representing a time and a location, which includes a hash value that is produced by transforming unencrypted information representing the time and the location (e.g., the unencrypted information may correspond to the product of unencrypted information representing the time and unencrypted information representing the location) using a hash algorithm. The first mobile apparatus then obtains a code generated using the code generating model based on the obtained information.

In a typical implementation, a user in charge of authenticating the digital certificate will be in the same location as the mobile apparatus at substantially the same time. By implementing the same method on another mobile apparatus associated with the user in charge of authenticating, the method allows quickly checking that the code is the same between the two devices, which means that the code has indeed been generated by the code generating model using the correct inputs.

In this sense, the method can be used for authenticating the digital certificate.

This is particularly advantageous as it is possible to perform an authentication without using a reader or a specific device.

Generating the code can be performed by the mobile apparatus or by a remote server.

According to a particular embodiment, generating the code includes a step of inputting the information representing the time and/or the location to the code generating model. This makes the generation process simple and efficient.

According to another particular embodiment, generating the code includes parametrizing the code generating model using the information representing the time and/or the location. This makes the generation process convenient for various types of the models.

In a particular example, generating the code includes a step of inputting the information representing one of the time and the location to the model and a step of parametrizing the model using the information representing another one of the time and the location. This could increase diversity in the output codes.

According to still another particular embodiment, the code generating model is a deep generative model, such as one that includes a GAN, a diffusion model, a VAE, a pixel convolutional neural network (hereinafter “CNN’), and/or, a transformer-based language model. Using a deep generative model is particularly secure as it is nearly impossible without access to the model to predict the output based on the time/the location. In fact, the output of these models can be considered to be nearly random.

According to still another particular embodiment, the method further includes, prior to obtaining the information representing the time and/or the location, a step of receiving a user input for rendering a code. For example, the user input may trigger the step of obtaining the information representing the time and/or the location.

Moreover, if the first mobile apparatus is configured to obtain the information representing the time, then the time may be a time point associated with the user input, a period including the time point associated with the user input, or, a reference time point in the period.

In particular, the time point associated with the user input may be a time when an operation is performed by the first mobile apparatus in response to the user input. For example, the time point associated with the user input may be: the time point when the user input is detected by the first mobile apparatus, the time point when the code generating model starts to generate the code in response to the user input, etc.

The period may be a pre-defined time window. The reference time point may be the start time, a midpoint, the end time, or any other specified time point in the period. This allows the code to be stable for the period of time, facilitating the verification of the code. The duration of the time window can be selected according to an expected level of security. For example, the size of the time window may be 5 minutes. This allows a special formatting of the time (before any possible transformation using a cryptographic technique) based on which the code is generated.

And/or, if the first mobile apparatus is configured to obtain the information representing the location, then the location may be: an estimated location associated with the user input, a predefined area including the estimated location, or, a reference location in the predefined area.

The estimated location associated with the user input may be a location where the first mobile apparatus is when the user input is detected. The location may be determined by a global positioning system (hereinafter “GPS”) sensor, by information identifying a Bluetooth beacon or a base station near the first mobile apparatus, etc. Or, the location may be determined by linking the estimated location to the predefined area. This area may have a certain volume and may be limited in size. The location may be estimated based on two-dimensional (hereinafter “2D”) or 3D map data.

Preferably, the obtained information represents both the time and the location.

As such, the code could reflect variations in time and/or locations associated with user inputs, making the verification even simpler.

Typically, the user can trigger this step prior to submitting the display of his/her mobile apparatus to a user in charge of authenticating.

According to still another particular embodiment, the information representing the time and/or the location includes encrypted information produced by using a cryptographic technique. As mentioned earlier, the encrypted information is produced by transforming unencrypted information representing the time and/or the location using the cryptographic technique. For example, the cryptographic technique may include an encryption technique or include a hash algorithm.

This makes it more challenging to fabricate counterfeit versions of the code, and will ensure the integrity of the unencrypted data before the transformation in a scenario where the first mobile apparatus transmits the information representing the time and/or the location to a separate mobile apparatus to generate the code.

According to still another particular embodiment, the information representing the time includes a time code. And/or, the information representing the location includes information identifying a geolocation, or information identifying a Bluetooth beacon or a base station. This makes the rendering process simple and efficient.

The entropy of the code is lower than a given threshold.

An image having an entropy lower than a given threshold can easily be recognized by a human as it differs from an image consisting of pure noise.

By way of example, if a deep generative model is used, it is possible to train the deep generative model using for example only low entropy images to generate codes having a low entropy level by using a loss function measuring a distance or similarity between outputs of the deep generative model and human-prepared image(s) having a low entropy level.

According to still another particular embodiment, the code generating model is configured to generate different codes based on different information representing different time or different locations, where the value of a measure of similarity between the different codes is lower than a preset threshold. Examples of the measure of similarity include cross-correlation, structure similarity index, multi-scale structure similarity index, etc.

According to still another particular embodiment, the method further includes, prior to the displaying step, a step of combining the code and the at least one element that is included in digital certificate to obtain a combined image. This will make the verification of the digital certificate easy and convenient. For example, the code may be superimposed on the at least one element as at least part of the background of the combined image.

According to still another particular embodiment, the code has a resolution greater than or equal to a preset threshold. This could enable the visibility of the code.

According to still another particular embodiment, after obtaining the digital certificate, the method further includes a step of verifying the digital certificate. The step of displaying the code is performed if the digital certificate is verified to be true or valid. Otherwise if the digital certificate is proven to be counterfeit or invalid, the method further includes a step of outputting an error message. The verifying step may further include the first mobile apparatus communicating with a remote server or checking a local database to verify the digital certificate.

According to still another particular embodiment, the method further includes a step of storing the time and/or the location represented by the obtained information, and/or, sending the time and/or the location represented by the obtained information to a remote server for storage. This embodiment allows to check the history of time and/or location, and could be particularly useful in situations such as a post-drinking accident.

In a second aspect, the present disclosure provides a method for authenticating a digital certificate. The method includes the method for rendering a code according to any embodiment in the first aspect, and further includes the following steps implemented by a second mobile apparatus:
obtaining the information representing the time and/or the location, obtaining a second code generated using the code generating model based on the information, and displaying the second code on a display of the second mobile apparatus, where the second code is same as the code.

In particular, the first mobile apparatus may be used by a person (e.g., a client of a bar) to produce his/her digital certificate, whereas the second mobile apparatus may be used by a verifier (such as a bartender) to verify the digital certificate (e.g., a driver's license) of the former person. As such, by comparing the codes displayed on both mobile apparatuses, the verifier can easily determine whether the digital certificate is genuine or valid.

According to a particular embodiment, the method further includes a step of displaying an option to display a third code generated using the code generating model, or, displaying the third code.

The third code is generated based on information representing an adjacent time to the time represented by the obtained information. The adjacent time may be a time point or interval that immediately follows or precedes the time represented by the obtained information.

In particular, the adjacent time may be prior to the time represented by the obtained information.

Or, the third code is generated based on information representing an adjacent time to a current time. The adjacent time may be a time point or interval that immediately follows or precedes the current time.

In particular, the adjacent time may be prior to the current time.

And/or, the third code is generated based on information representing an adjacent location to the location represented by the obtained information or to a current location. The adjacent location may be a location that neighbors the location represented by the obtained information or the current location. For example, the location represented by the obtained information or the current location may be a predefined area, and the adjacent location may be another pre-defined area that neighbors the former predefined area. The current location may be the location of the apparatus that implements this step.

This step may be implemented by the first mobile apparatus, the second mobile apparatus, or, a third mobile apparatus.

This embodiment allows a verifier or a user/customer to check the code generated based on an adjacent time point/window. This may be especially useful when another verifier cannot verify the digital certificate of the user/customer until the code displayed on the first mobile apparatus has expired, meaning that the second or third mobile apparatus, when used by this verifier for the verification, is unable to generate the same code based on the current time. This feature can also help the verifier to check the validity of the code shown on the user's mobile apparatus more easily when the GPS data from the user's apparatus doesn't match the GPS data from the verifier's apparatus due to possible inaccuracies.

In a third aspect, the present disclosure provides the first mobile apparatus. The first mobile apparatus includes a display, a memory configured to store instructions and a processor configured to execute the instructions to implement the method according to any embodiment in the first aspect, and/or, to implement the corresponding step according to the last embodiment of the second aspect.

In particular, when the processor is configured to execute the instructions to implement any displaying step described in the first aspect, the processor controls the display to implement the corresponding displaying step.

In a fourth aspect, the present disclosure provides a system for authenticating a digital certificate which includes the first mobile apparatus and the second mobile apparatus. The second mobile apparatus includes a display, a memory configured to store instructions, and a processor configured to execute the instructions to implement the corresponding steps according to any embodiment of the second aspect.

The system may further include the third mobile apparatus, which includes a display, a memory configured to store instructions, and a processor configured to execute the instructions to implement the corresponding step according to the last embodiment of the second aspect.

In particular, when the processor of the second or third mobile apparatus is configured to execute the instructions to implement any displaying step described in the second aspect, the processor controls its display to implement the corresponding displaying step.

The steps of the methods in the first or second aspect may be determined by computer program instructions. Consequently, in a fifth aspect, the present disclosure provides a computer program product including instructions which, when executed by a mobile apparatus, cause the mobile apparatus to implement the method according to any embodiment in the first aspect.

It should be noted that this does not necessarily mean that the instructions must explicitly specify any of the steps of obtaining information representing a time and/or a location. Instead, e.g., the obtaining step may be reflected in a parameter used in the instructions.

In a particular embodiment, the computer program product further includes instructions which, when executed by another mobile apparatus, cause the other mobile apparatus to perform steps of:
obtaining the information representing the time and/or the location, obtaining a second code generated using the code generating model based on the information, and displaying the second code on a display of the other mobile apparatus, wherein the second code is same as the code.

The computer program product may further include instructions which, when executed by a mobile apparatus, cause this mobile apparatus to display a third code, or, to display a third code, where the third code is generated using the code generating model based on information representing an adjacent time to the time represented by the obtained information or to a current time. The mobile apparatus may be either of the two mobile apparatuses described above or another mobile apparatus.

This program product can use any programming language and take the form of source code, object code or a code intermediate between source code and object code, such as a partially compiled form, or any other desirable form.

In a sixth aspect, the present disclosure provides one or more information media storing the computer program product according to any embodiment of the fifth aspect. In particular, the one or more information media may be non-transitory.

The one or more information media can be any entity or device capable of storing the program. For example, the one or more information media can include storage means such as a ROM, for example a CD ROM or a microelectronic circuit ROM, or magnetic storage means, for example a diskette (floppy disk) or a hard disk.

Alternatively, the one or more information media can include an integrated circuit in which the program is incorporated, the circuit being adapted to execute the method in question or to be used in its execution.

### BRIEF DESCRIPTION OF THE DRAWINGS

Embodiments of the disclosure and advantages thereof will be described below in detail, by way of example, with reference to the accompanying schematic drawings introduced as follows.

FIG. 1 illustrates an exemplary system in accordance with one or more embodiments disclosed herein.

FIG. 2 is a flowchart illustrating a method for rendering a code in accordance with an example disclosed herein.

FIGS. 3-4 are more precise flow charts of the example of FIG. 2.

FIG. 5 is a flow chart illustrating a method for authenticating a digital certificate in accordance with another example.

FIG. 6 is a block diagram illustrating a first mobile apparatus in accordance with another example.

FIG. 7 is a block diagram illustrating a second mobile apparatus in accordance with another example.

For simplicity and clarity of illustration, the same reference numerals will be used throughout the figures to refer to the same or like parts, unless indicated otherwise.

### DESCRIPTION OF PARTICULAR EMBODIMENTS

We will now describe a method and mobile apparatus for rendering code, method and system for authenticating digital certificate, which, overall, add a level of security to authentication of a digital certificate.

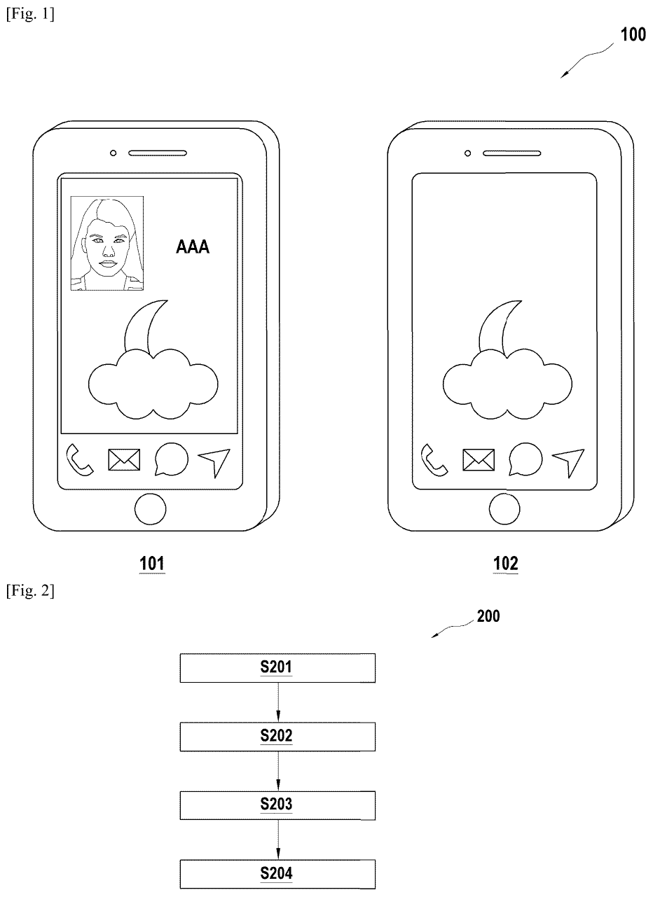

FIG. 1 illustrates an example system 100 in which various embodiments of the present disclosure may be employed. As illustrated by FIG. 1, the system 100 includes a first mobile apparatus 101 and a second mobile apparatus 102. Though illustrated as a smartphone in FIG. 1, examples of the first mobile apparatus 101 and the second mobile apparatus 102 further include a tablet, a wearable device, etc.

As an example, the first mobile apparatus 101 and the second mobile apparatus 102 may be configured to communicate with a remote server (not shown).

In the example as illustrated by FIG. 1, while being used by a user to produce her digital certificate, the first mobile apparatus 101 displays the digital certificate together with a graphical code. For example, the digital certificate can be a driving license, an identity card, etc. Here, the digital certificate is shown with an image of a face and accompanying text (for example personal information).

The graphical code is superimposed on the image, here in a blank portion of the digital certificate in the shape of a cloud and a crescent. For example, the graphical code can be used as a background of the digital certificate, so as not to impede reading the document.

As will be described hereinafter, the user can use an application to display the digital certificate along with an obtained code.

Meanwhile, the second mobile apparatus 102 is used by a certifier who wants to visually authenticate the digital certificate and displays the same graphical code (for example using the same application). By comparing the graphical codes displayed on both mobile apparatuses 101 and 102 and finding that they are identical to each other because both apparatuses are in the same time window and location (geographic boundary), the certifier is able to confirm that the digital certificate is genuine or valid. The following description describes how this is implemented in detail.

On FIG. 1, mobile apparatus 102 only shows the graphical code, which amounts to using a verifier mode. It is also possible that the verifier chooses to display the graphical code in a user mode, where the mobile apparatus 102 displays the graphical code along with the digital certificate of the verifier, although in this case the verifier will only take into account the graphical code that accompanies the certificate and not the certificate.

FIG. 2 illustrates a method 200 for rendering a code. The method can be implemented by the mobile apparatus 101 described with reference to FIG. 1 and includes the following steps S201-S204.

In step S201, the mobile apparatus 101 obtains a digital certificate such as a digital ID document.

The digital ID document may be a driver's license, a passport, an ID card, a residence card, etc.

For example, in the step S201, the digital certificate may be received from a user, or may be retrieved from the database of a server of an authority. The step S201 may be triggered by a user input.

In particular, if the digital certificate is received from a user, it may be further authenticated or validated by the first mobile device 101 communicating with a remote server or checking a local database. If the digital certificate is considered to be fake or invalid (e.g., it is not found in the remote or local database), the first mobile device 101 may reject the digital certificate without performing the remaining steps of the method and output an error message.

In step S202, the mobile apparatus 101 obtains information representing a time and/or a location.

For example, the information representing the time includes a time code. And/or, the information representing the location includes information identifying a geolocation such as GPS coordinates, or information identifying a Bluetooth beacon or a base station.

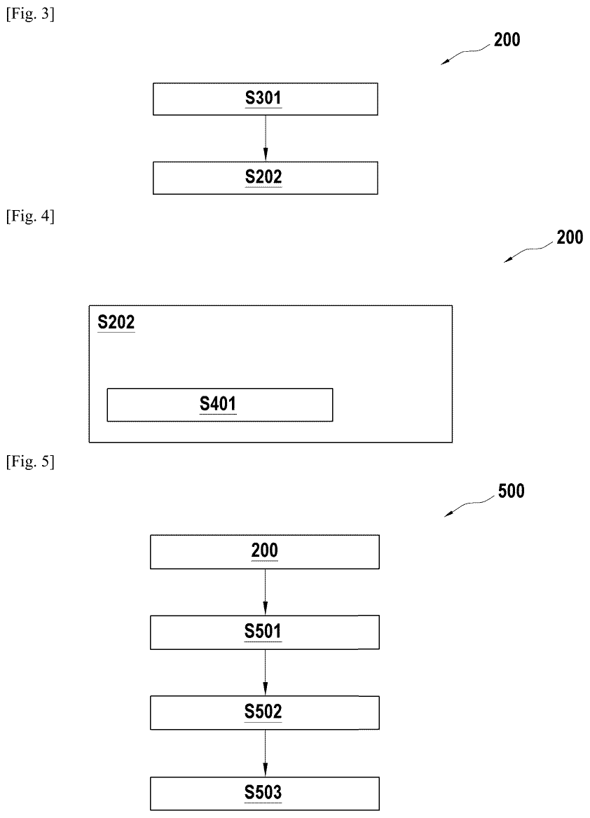

Additionally or alternatively, the information representing the time is obtained by first determining a period including an original time point (e.g., a time point associated with a user input as described below with reference to FIG. 3) according to a predefined rule, and then determining a reference time point within the period as the information representing the time.

For example, when detecting the user input, the mobile apparatus 101 may determine the time (e.g., 8.15 am on May 25, 2023) when the user input is detected, search for a period (e.g., between 8 am and 10 am on May 25, 2023) including the time when the user input is detected in a given timetable, and then use the start time of the period (8 am on May 25, 2023) as the information representing the time.

In a further example compatible with any other example herein, the code generating model is a deep generative model.

In step S203, the mobile apparatus 101 obtains a first code generated using a code generating model based on the information representing the time and/or the location.

In particular, in step S203, the mobile apparatus may generate the first code locally, or receive it from the remote server after transmitting the information representing the time and/or the location to the server.

Moreover, to generate the first code, the information representing the time and/or the location may be used as input data of the code generating model.

Alternatively or additionally, the code generating model may be parameterized using the information representing the time and/or the location to generate the first code.

In step S204, the mobile apparatus 101 displays the first code along with at least one element that is included in the digital certificate on a display of the first mobile apparatus.

As an example, as illustrated by FIG. 1, the first code may be a graphical code that is imposed on the digital certificate to obtain a combined image prior to the step S204. The first code may be the background of the combined image or appear in a certain position within the combined image. Accordingly, in step S204, the mobile apparatus 101 displays the combined image.

Since the first code is generated using a code generating model based on the information representing a time and/or a location, the appearance/content of the first code varies with different time and/or different locations and could be unpredictable (in particular, the model is configured to output different codes for different locations and/or time). Accordingly, verification of the digital certificate using the first code is simple, efficient and more secure than the prior art.

As illustrated by FIG. 3, in an example compatible with any other example herein, the method further includes a step S301 of receiving a user input for rendering a code prior to the step S202. The user input may trigger the step S202. Accordingly, the time and/or the location represented by the information obtained at the step S202 may be associated with the user input.

As an example, the time may be the time point when the user input is detected, and/or, the location may be the location of the first mobile apparatus 101 when the user input is detected. As mentioned above, the method can be implemented through an application of a mobile apparatus. This application has an interface to allow this triggering.

As illustrated by FIG. 4, in another example compatible with any other example herein, the step S202 includes a step S401 of transforming unencrypted information representing the time and/or the location using a cryptographic technique. The unencrypted information may be the information described above. The cryptographic technique may be a hash algorithm such as secure hash algorithm-256, message digest 5, etc. In particular, the step S401 may be performed in order to transmit the transformed information to the server.

In a further example compatible with any other example herein, the entropy of the first code is lower than a given threshold to ensure that the first code can be easily validated by human eyes.

FIG. 5 illustrates a method 500 for authenticating a digital certificate. The method includes the steps of the method 200 according to any of the examples described above, and further includes the following steps S501-S503, which are implemented by the second mobile apparatus 102.

The mobile apparatus 102 obtains the information representing the time and/or the location described above in step S501, obtains a second code generated using the code generating model based on the information in step S502, and displays the second code on a display of the second mobile apparatus 102 in step S503. The second code is the same as the first code described above.

As such, by comparing the second code displayed on the second mobile apparatus 102 with the first code, the human verifier is able to validate the digital certificate visually because the digital certificate is valid only when the code displayed on the first mobile apparatus 101 is the same to the code displayed on the second mobile apparatus 102.

In a particular example, after the step S501, the mobile apparatus 102 displays an option (not shown) to display a third code generated using the code generating model based on information representing an adjacent time prior to the time represented by the information obtained in step S501. In this particular example, this option is displayed at the same time as the second code. For example, it may be a button displayed under the second code. When receiving a user input to select the option, the second mobile apparatus 102 displays the third code.

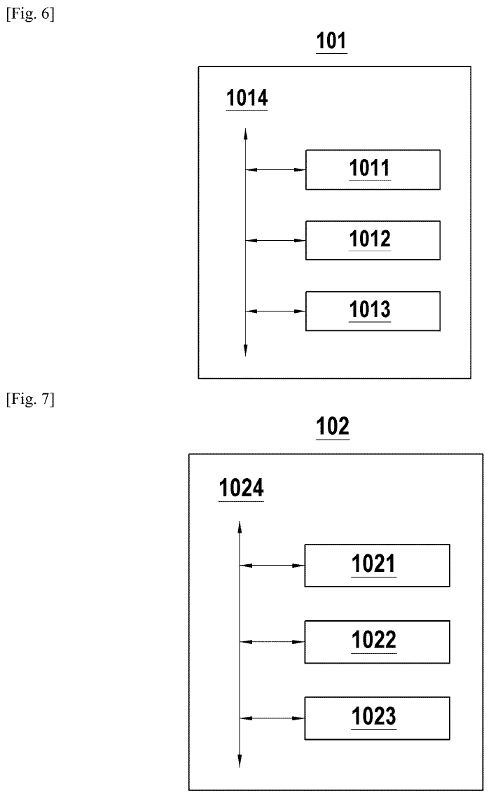

FIG. 6 illustrates the first mobile apparatus 101, which includes a display 1011, a memory 1012 and a processor 1013. The memory 1012 is configured to store instructions, and the processor 1013 is configured to execute the instructions to implement the method 200 according to any example thereof.

FIG. 7 illustrates the second mobile apparatus 102, which includes a display 1021, a memory 1022 and a processor 1023. The memory 1022 is configured to store instructions, and the processor 1023 is configured to execute the instructions to implement the method 500 according to any example thereof.

In an example compatible with any other example herein, the first mobile apparatus 101 or the second mobile apparatus 102 further includes a user input component configured to receive user input. Examples of the component include a touch-sensitive screen, a keyboard, a voice response system, a camera, a microphone, or any other device for detecting input from a user.

In particular, the processor 1011 or 1012 includes a central processing unit (hereinafter “CPU”), a vision processing unit (hereinafter “VPU”), a graphics processing unit (hereinafter “GPU”), a tensor processing unit (hereinafter “TPU”), a neural processing unit (hereinafter “NPU”), a neural processing engine, a core of a CPU, VPU, GPU, TPU, NPU or another processing device, an application processor, a display controller, an application specific integrated circuit (hereinafter “ASIC”), a field programmable gate array (hereinafter “FPGA”), a coprocessor, or any other hardware configured to function as a processing unit.

The memory 1012 or 1022 can include any available medium that can be accessed by the mobile apparatus 101 or 102 in the form of volatile or non-volatile memory. The memory 1012 or 1022 may be a random access memory (hereinafter “RAM”), a dynamic random access memory (hereinafter “DRAM”), a static random access memory (hereinafter “SRAM”), any other form of volatile memory known in the art, a magnetic hard disk, an optical disk, a floppy disk, a flash memory, an electrically programmable memory (hereinafter “EPROM”), an electrically erasable and programmable memory (hereinafter “EEPROM”), any other form of non-volatile memory known in the art, a data server, etc.

The first mobile apparatus 101 or the second mobile apparatus 102 may further include a communication component configured to communicate with external devices via wired or wireless network(s) by transmitting or receiving network signals over network(s). Examples of the communication component include a network interface card such as an Ethernet card, an optical transceiver, a radio frequency transceiver, a universal serial bus controller, or any other device that can send or receive information.

As shown by FIGS. 6 and 7, different components of the mobile apparatus 101 or 102 may be directly or indirectly coupled to each other physically, communicatively, or operationally via a communication channel 1014 or 1024. The communication channel may include a network connection, or any other means for communicating data.

This disclosure having been described in particular embodiments, it is clear that it is susceptible to numerous modifications and embodiments within the scope of the disclosure as defined by the following claims.

1. A method for rendering a code implemented by a first mobile apparatus, characterized by comprising:
obtaining a digital certificate;
obtaining information representing a time and/or a location;
obtaining a code generated using a code generating model based on the information representing the time and/or the location; and
displaying the code along with at least one element that is comprised in the digital certificate on a display of the first mobile apparatus,
the code generating model being a deep generative model and the entropy of the code is lower than a given threshold, the code being a graphical code displayed as a background of the digital certificate.

2. The method according to claim 1, wherein generating the code comprises:
inputting the information representing the time and/or the location to the code generating model.

3. The method according to claim 1, wherein generating the code comprises parameterizing the code generating model using the information representing the time and/or the location.

4. The method according to claim 1, further comprising, prior to obtaining the information representing the time and/or the location:
receiving a user input for rendering a code, wherein
the location represented by the obtained information is: an estimated location associated with the user input, a predefined area including the estimated location, or, a reference location in the predefined area; and/or,
the time represented by the obtained information is: a time point associated with the user input, a period comprising the time point associated with the user input, or, a reference time point in the period.

5. The method according to claim 1, wherein the information representing the time and/or the location comprises encrypted information produced by using a cryptographic technique.

6. The method according to claim 5, wherein the encrypted information comprises a hash value corresponding to the time and the location.

7. The method according to claim 1, wherein the information representing the time comprises a time code; and/or
the information representing the location comprises information identifying a geolocation, or, information identifying a Bluetooth beacon or a base station.

8. The method according to claim 1, further comprising, prior to the displaying step:
combining the code and the at least one element that is comprised in the digital certificate to obtain a combined image.

9. A method for authenticating a digital certificate,
comprising the method according to claim 1, and further comprising following steps implemented by a second mobile apparatus:
obtaining the information representing the time and/or the location, obtaining a second code generated using the code generating model based on the information, and displaying the second code on a display of the second mobile apparatus, wherein the second code is same as the code.

10. The method according to claim 9, further comprises:
displaying an option to display a third code, or, displaying a third code,
wherein the third code is generated by using the model based on information that represents an adjacent time and/or an adjacent location, the adjacent time being a time adjacent to the time represented by the obtained information or adjacent to a current time, the adjacent location being a location adjacent to the location represented by the obtained information or adjacent to a current location.

11. A mobile apparatus for rendering a code, comprising:
a display;
a memory configured to store instructions; and
a processor configured to execute the instructions to implement the method according to claim 1.

12. A system for authenticating a digital certificate, comprising the mobile apparatus according to claim 11, and another mobile apparatus comprising:
a display;
a memory configured to store instructions; and
a processor configured to execute the instructions to perform steps of:
obtaining the information representing the time and/or the location, obtaining a second code generated using the code generating model based on the information, and controlling the display to display the second code on a display of the other mobile apparatus, wherein the second code is same as the code.

13. A computer program product, comprising instructions which, when executed by a mobile apparatus, cause the mobile apparatus to implement the method according to claim 1.
